(19) United States
(12) Patent Application Publication
(10) Pub. No.: US 2026/0165346 A1
(43) Pub. Date: Jun. 18, 2026

(54) Multi-Textural, Fully Edible Dog Treat

(71) Applicant: Blue Buffalo Enterprises, Inc., Wilton, CT (US)

(72) Inventors: Lynn K. Barton, St. Louis Park, MN (US); Emily Lauren Fort, Cave Springs, AR (US); Megan Keough, Minneapolis, MN (US); James Larsen, Pea Ridge, AR (US); Thaisa Sibila Lemos, São Paulo (BR); James Lombel, St. Michael, MN (US); Jie Sun, Plymouth, MN (US); Rachel Vecchio, Hudson, WI (US); Morgan Nicole Whitecotton, Minneapolis, MN (US); Scott K. Whitman, New Hope, MN (US)

(73) Assignee: Blue Buffalo Enterprises, Inc., Wilton, CT (US)

(21) Appl. No.: 19/400,673

(22) Filed: Nov. 25, 2025

Related U.S. Application Data
(60) Provisional application No. 63/735,398, filed on Dec. 18, 2024.

(51) Int. Cl. A23K 40/30; A23K 10/20; A23K 10/30; A23K 50/40

(52) U.S. Cl. CPC A23K 40/30; A23K 10/20; A23K 10/30; A23K 50/40

(57) ABSTRACT

A multi-textured, fully edible pet treat, which can be consumed at ambient or even frozen conditions, includes a shell having a base and a peripheral wall which collectively defines an interior filler region. Within the filler region is at least one upstanding barrier member, preferably a plurality of spaced upstanding barrier members, fixed to the peripheral wall or cantilevered from the base. The shell and barrier members are structural in nature, while being formed from at least one edible material. On the other hand, the filler region is provided with a distinct, edible filler material which extends throughout the filler region, including between and around the various barrier members. When provided to a dog, the barrier members hamper the pet's ability to expeditiously consume the filler material, instead essentially mandating the dog lick between and around the barrier member(s), thereby providing simulation and prolonging the overall consumption time.

### CROSS REFERENCE TO RELATED APPLICATIONS

This application claims the benefit of U.S. Provisional Patent Application Ser. No. 63/735,398, which was filed on Dec. 18, 2024 and titled “Multi-Textural, Fully Edible Dog Treat”, pending. The entire content of this application is incorporated by reference.

### FIELD OF THE INVENTION

The invention generally pertains to pet treats and, more particularly, to a multi-textured, fully edible dog treat which can be supplied at ambient or refrigerated temperatures and is configured to provide a stimulating and long-lasting eating experience for a dog.

### BACKGROUND OF THE INVENTION

Pet owners enjoy feeding treats to their pets to show affection, create stimulating moments for their pets and/or reward their pets. As consumers are increasingly treating their pets like family members, pet owners often look to find ways to occupy their pets when it is not possible to give them the attention they deserve. By way of example, it has been proposed to provide a dog toy into which a food product can be added. The body of the toy is made of rubber and designed to limit access to the food product, forcing the dog to take an extended period of time to lick the food product from within the body of the toy. Of course, after the dog is finished with the toy, the item must be thoroughly cleaned, both inside and out, which is not a pleasant dog owner task. With all this in mind, it would be beneficial to provide a pet treat designed to mentally and/or physically stimulate a pet for an extended period of time, while made to be entirely consumed, either at ambient or refrigerated temperatures, thereby providing a lickable and chewable pet treat but avoiding the known owner related cleaning issues.

### SUMMARY OF THE INVENTION

Described herein is a pet treat designed to stimulate and occupy a pet for an extended period of time. More specifically, the invention concerns providing a multi-textured, fully edible pet treat which can be consumed at ambient or refrigerated (including freezing) temperatures. In accordance with the invention, the pet treat item includes a shell including a base and a peripheral wall which collectively define an interior filler region. Within the filler region there is at least one upstanding barrier member, preferably a plurality of upstanding barrier members which are spaced from each other, fixed to the peripheral wall or cantilevered from the base. The shell and barrier members are structural in nature, while being formed from at least one edible material. On the other hand, the filler region is provided with a distinct, edible filler material, such as a soft or pliable material which extends throughout the filler region, including between and around the barrier member(s). When provided to a dog, for example, the one or more barrier members hamper the pet's ability to expeditiously consume the filler material, instead mandating the dog lick between and around the barrier member(s), thereby prolonging the overall consumption time. Either commensurate with some of the filler material or after the filler material is fully or partially consumed, the shell and barrier members which, while not brittle or crumbly but are harder than the filler material, provide the dog with a chewable consumption experience.

In particularly preferred embodiments, the shell and barrier members are formed from one or more meat products through extrusion, molding, stamping or the like production processes, while the filler material constitutes a firm, yet pliable, edible material such as peanut butter. The meat product can be made from various meats, such as beef or chicken, as is known for use in various dog chew treats. Overall, only AFFCO natural ingredients are employed. Therefore, the entire pet treat is highly digestible and, with the multi-texture and structural nature of the overall product, provides an enticing, stimulating and rather time-consuming eating experience for the pet. In addition, the pet treat can be advantageously consumed from ambient to frozen conditions, thereby representing a transformative pet treat which exhibits a shelf life ranging between 18 months under ambient storage conditions and about 24 months when stored frozen.

The pet treats in accordance with the invention can take a wide range of shapes and sizes, with certain embodiments establishing pet treats which are generally puck-shaped, having an overall diameter in the order of approximately 2-6 inches and a thickness or depth of about 0.5-3 inches. In addition to the structure discussed above, the dog treat can also be formed with one or more additional features which prolongs the eating experience and adds additional stimulation to the dog. By way of example, the base of the dog treat could be formed with one or more geometric structures, such as a central, semi-spherical support member providing a wobbling support effect, which adds a play value and further limits the ability of a dog to expeditiously devour the filler material.

Additional objects, features and advantages of the present invention will become more fully apparent from the following detailed description of the invention with reference to the accompanying drawings wherein like reference numerals refer to corresponding parts in the several views.

### BRIEF DESCRIPTION OF THE DRAWINGS

FIG. 1 is an upper perspective view of a multi-textured, fully edible dog treat constructed in accordance with the invention.

FIG. 2 is an upper perspective view of the dog treat of FIG. 1 with a filling material thereof removed.

FIG. 3 is a top view of the dog treat of FIG. 2.

FIG. 4 is a bottom view of the dog treat.

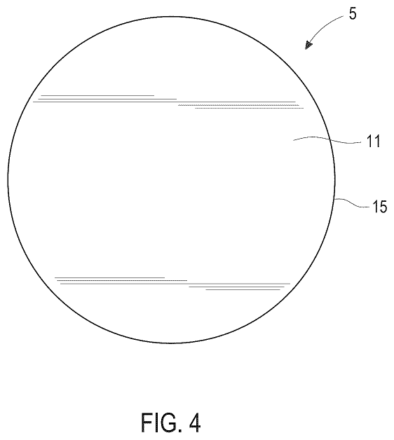

FIG. 5 shows three dog treats of the invention arranged for compact packaging.

FIG. 6 is a lower perspective view of a multi-textured, fully edible dog treat constructed in accordance with a modified embodiment of the invention.

### DETAILED DESCRIPTION OF THE INVENTION

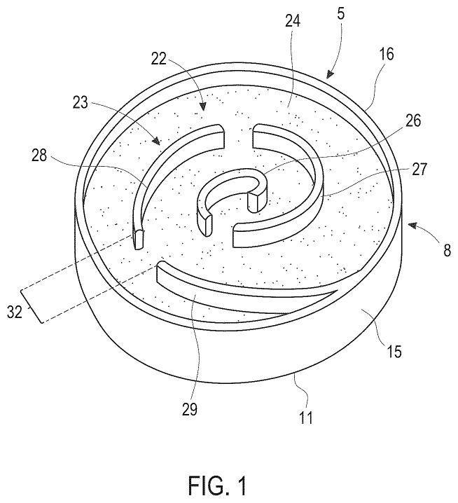

With initial reference to FIG. 1, a multi-textured pet treat made in accordance with the invention is generally indicated at 5. As shown, pet treat 5 includes a shell 8 having a base or bottom 11 and an upstanding, peripheral wall 15 terminating in an upper annular rim 16. Within peripheral wall 15 is established an interior filler region 22. Formed within interior filler region 22 is a segmented interior wall assembly generally indicated at 23. As will become more fully evident below, segmented interior wall assembly 23 can take various shapes, with the exemplary embodiment depicted covering spaced segments which, if connected, would combine to establish a spiral within peripheral wall 15. At this point, it should simply be understood that segmented interior wall assembly 23 can take various forms/configurations without departing from the invention. Also located with interior wall assembly 23 and extending throughout interior filler region 22, preferably from base 11 to at or below a level of upper annular rim 16, is a filler material 24. Given the existence of segmented interior wall assembly 23, filler material 24 extends about and between the various segments of interior wall assembly 23 as will be detailed more fully below.

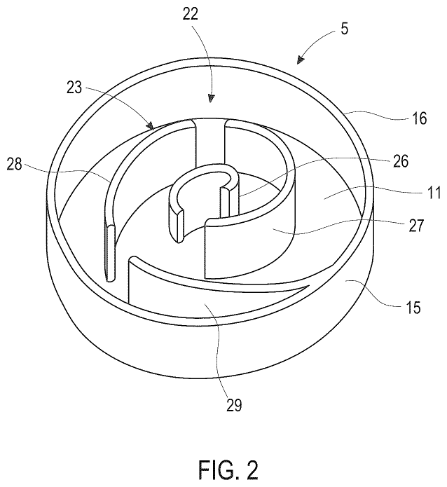

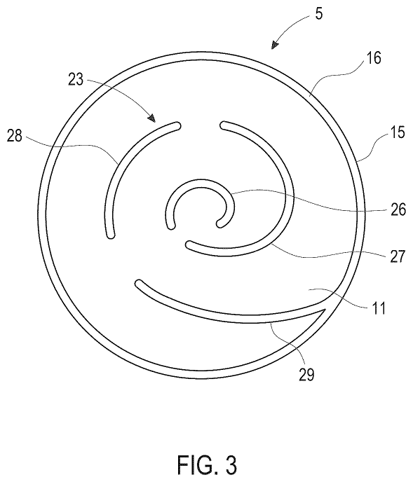

FIGS. 2 and 3 depict pet treat 5 without filler material 24 and further illustrate the structure of interior wall assembly 23. As shown in accordance with this exemplary embodiment, interior wall assembly 23 includes a plurality of upstanding barrier members 26-29, each of which is shown to extend upward from base 11. More specifically, in this embodiment, barrier members 26-28 are cantilevered from base 11, while barrier member 29 is integrated with both base 11 and peripheral wall 15. Again, the exact shape or geometrical configuration of barrier members 26-29 can vary. However, important in connection with the invention is that the barrier members 26-29 are spaced from each other such that interior wall assembly 23 is segmented and gaps, such as gap 32 between barrier members 28 and 29, are established. This overall spacing and gap creation arrangement advantageously provides for multiple flow paths or channels when filler material 24 is introduced into interior filler region 22 and contributes to stimulating and occupying a pet for an extended period of time during product consumption as emphasized further below.

In preferred embodiments, pet treat 5 is formulated and designed as a dog treat and, correspondingly, is suitably formulated for consumption by a dog. As indicated above, the entire pet treat 5 is edible, with shell 8 and filler material 24 preferably being made from different edible ingredients. By way of a particular example, shell 8 and barrier members 26-29 are formed from one or more meat products, while filler material 24 constitutes a firm, yet pliable, edible material such as peanut butter. The meat product can be made from various meats, such as beef or chicken, as is known for use in various dog chew treats. Overall, only AFFCO (Association of American Feed Control Officials), or its replacement regulatory pathway for animal food natural ingredients, natural ingredients are employed. Therefore, the entire pet treat 5 is highly digestible and, with the multi-texture and structural nature of the overall product, provides an enticing, stimulating and rather time-consuming eating experience for the dog. In addition, the pet treat can be advantageously consumed from ambient to frozen conditions, thereby representing a transformative pet treat which exhibits a shelf life ranging between 18 months under ambient storage conditions and about 24 months when stored frozen.

The shelf-stable, multi-textured, fully edible dog treat of the invention can be made by various methods. In certain embodiments, single, twin or co-extruder systems are employed. In connection with the single or twin forms, the shell and barrier members are preferably extruded, followed by a depositor or injector (not shown) to fill up the interior filler region. With co-extrusion, both the shell/barrier members and filler material can be introduced in a compact manufacturing operation. In other embodiments, the shell and barrier members are formed through injection molding, while a depositor is employed to add the filler material. In still other embodiments, a combination of extrusion and rotary molding/stamping can be employed to create the shell and barrier members, while a depositor is again used to add the filler material. Preferably the filler material is added (filled upon the base) at a viscosity which provides a significant degree of self-leveling within the shell. In certain embodiments, the filler material can be added to a level approximately equal to tops of the barrier members, yet below a level of the peripheral wall of the shell, with the filler material accounting for about 20-25% of the total product weight. Thereafter, a topping material can be applied to create a pattern within the peripheral wall of the shell, with the pattern extending along and across the tops of at least a majority of the barrier walls. For example, for the embodiment depicted, a topping layer in the form of a bead could be added atop the filler material to visually form a complete spiral. As the location and number of barrier members can be readily varied in accordance with the invention, the pattern can take a wide range of forms, such as a spiral, an animal shape, a honeycomb configuration, etc. The topping material can be made out of the same material as the shell or another edible material can be employed, with the topping material being deposited following the inclusion of the filler material. Certainly, pet treats in accordance with the invention can take a wide range of shapes and sizes, with certain embodiments establishing pet treats which are generally puck-shaped, having an overall diameter (i.e., peripheral wall 15 is substantially circular) in the order of approximately 2-6 inches and a thickness or depth of about 0.5-3 inches, more preferably a diameter between 2-4.5 inches and a thickness or depth of about 0.5-1.5 inches.

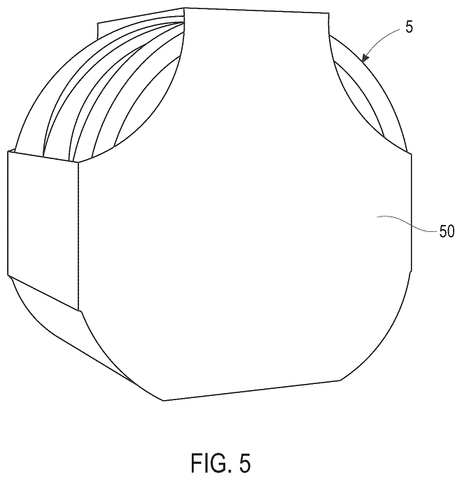

Obviously, a wide range of packaging options exist for the pet treats of the invention. For the sake of completeness, FIG. 5 illustrates one preferred packaging arrangement wherein three pet treats 5 made in accordance with the invention are collectively wrapped in a paperboard packaging 50 which exposes peripheral sections of the pet treats, yet securely holds the products together until the packaging 50 is removed and provides ample surface area for product identification, ingredients listings, and other product related information.

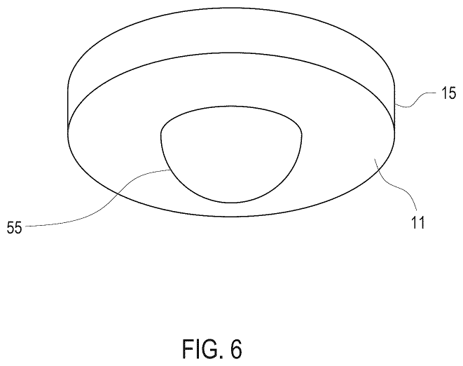

In addition to the structure discussed above, the pet treat can also be formed with one or more additional features which prolongs the eating experience and adds additional stimulations to the dog. By way of example, reference is made to FIG. 6 which illustrates the inclusion of a geometric structure as part of the shell to achieve these additional goals. In accordance with this product variation, the pet treat is formed with one or more geometric structures to add a play value and further limit the ability of a dog to expeditiously devour the filler material. In the exemplary embodiment shown, in addition to the structure of the above-described embodiment, an edible geometric support member 55, shown as a central, semi-spherical support, is formed on the lower surface of base 11, projecting from base 11 in a direction away from interior filler region 22. As should be readily apparent, geometric support member 55 provides a wobbling support effect, basically making it more difficult for a dog to easily access desired regions of filler material 24 with his/her tongue, while also adding to the potential play value of the pet treat. At this point, it should be recognized that, although a dome-type geometric support member has been shown and described, a wide range of geometric support configurations could be employed to similarly alter the support of the pet treat on a surface versus just providing the flat base or bottom. Overall, although described with respect to preferred embodiments of the invention, it should be readily apparent that various changes and/or modifications can be made without departing from the overall invention disclosed.

1. A multi-textured, fully edible pet treat comprising:
a shell including a base and a peripheral wall which collectively define an interior filler region;
at least one upstanding barrier members within the interior filler region, said shell and barrier members being structural in nature while being formed from at least one edible material; and
a filler material made from another edible material which is distinct from the at least one edible material, with said filler material extending throughout the filler region, including between and around the at least one barrier member.

2. The multi-textured, fully edible pet treat of claim 1, wherein at least one barrier member includes a plurality of upstanding barrier members spaced from each other within the interior filler region.

3. The multi-textured, fully edible pet treat of claim 2, wherein at least some of said barrier members are cantilevered from the base of the shell.

4. The multi-textured, fully edible pet treat of claim 1, wherein the at least one barrier member extends above the filler material in the interior filler region.

5. The multi-textured, fully edible pet treat of claim 1, wherein the pet treat is generally puck-shaped, with the peripheral wall being substantially circular.

6. The multi-textured, fully edible pet treat of claim 5, wherein the pet treat has an overall diameter in the order of approximately 2-6 inches and a thickness of about 0.5-3 inches.

7. The multi-textured, fully edible pet treat of claim 1, wherein pet treat has a shelf life of at least 18 months when stored under ambient conditions and a shelf life of at least 24 months when stored frozen.

8. The multi-textured, fully edible pet treat of claim 7, wherein the at least one edible material includes beef or chicken, and the another edible material constitutes peanut butter.

9. The multi-textured, fully edible pet treat of claim 1, further comprising a geometric support member projecting from the base, away from the interior filler region.

10. The multi-textured, fully edible pet treat of claim 9, wherein the geometric support member constitutes a centrally located, semi-spherical support member.

11. A method of producing multi-textured, fully edible pet treat comprising:
forming a shell including a base and a peripheral wall which collectively define an interior filler region;
forming at least one upstanding barrier member within the interior filler region, said shell and barrier members being structural in nature while being formed from at least one edible material; and
adding a filler material, made from another edible material which is distinct from the at least one edible material, throughout the filler region, including between and around the at least one barrier member.

12. The method of claim 11, wherein the at least one barrier member includes a plurality of upstanding barrier members spaced from each other within the interior filler region between and around which the filler material is added.

13. The method of claim 12, further comprising cantilevering at least some of said barrier members from the base of the shell.

14. The method of claim 11, wherein the filler material is added to a level below the at least one barrier member in the interior filler region.

15. The method of claim 11, further comprising formulating the pet treat to have a shelf life of at least 18 months when stored under ambient conditions and a shelf life of at least 24 months when stored frozen.

16. The method of claim 15, wherein the at least one edible material includes beef or chicken, and the another edible material constitutes peanut butter.

17. The method of claim 11, further comprising forming the shell to be generally puck-shaped, with the peripheral wall being substantially circular.

18. The method of claim 17, wherein the pet treat has an overall diameter in the order of approximately 2-6 inches and a thickness of about 0.5-3 inches.

19. The method of claim 11, further comprising establishing a geometric support member projecting from the base, away from the interior filler region.

20. The method of claim 19, further comprising forming the geometric support member as a centrally located, semi-spherical support member.
